(19) United States
(12) Patent Application Publication
(10) Pub. No.: US 2011/0143928 A1
(43) Pub. Date: Jun. 16, 2011

(54) CATALYTIC FILTER OR SUBSTRATE CONTAINING SILICON CARBIDE AND ALUMINUM TITANATE

(75) Inventor: Carine Dien-Barataud, Isle (FR)

(73) Assignee: SAINT-GOBAIN CENTRE DE RECHERCHES ET D'ETUDES EURO, Courbevoie (FR)

(21) Appl. No.: 12/994,276

(22) PCT Filed: May 26, 2009
(86) PCT No.: PCT/FR09/50978

§ 371 Date: Feb. 17, 2011

(30) Foreign Application Priority Data
May 29, 2008 (FR) 0853525

(51) Int. Cl. B01J 27/224; B01J 32/00; B01J 35/04; B01J 35/10

(52) U.S. Cl. 502/178; 502/439

(57) ABSTRACT

The invention relates to a structure of the honeycomb type, made of a porous ceramic material, said structure being characterized in that the porous ceramic material of which it is composed comprises at least partly 45 to 90% by weight of silicon carbide SiC, preferably in the alpha form, and 10 to 55% by weight of a ceramic oxide phase substantially in the form of aluminum titanate Al₂TiO₅, said material also having a porosity greater than 10%, and a median pore diameter of between 5 and 60 microns.

The invention relates to the field of catalytic filtering structures or substrates, notably used in an exhaust line of an internal combustion engine of the diesel type.

Catalytic filters enabling gases to be treated and soot to be removed coming from a diesel engine are well known in the prior art. All these structures more often have a honeycomb structure, one of the faces of the structure for the entry of exhaust gases to be treated, and the other face for evacuation of the treated exhaust gases. The structure includes, between the inlet and evacuation faces, an assembly of adjacent conduits or channels with axes parallel to each other, separated by porous walls. The conduits are closed at one or other of their ends in order to delimit inlet chambers opening along the inlet face and outlet chambers opening along the evacuation face. The channels are alternately closed in an order such that the exhaust gases are constrained, during their passage through the honeycomb body, to pass through the sidewalls of the inlet channels so as to join the outlet channels. In this way, particles or soot are deposited and accumulate on the porous walls of the filtering body.

In a known manner, during its use, the particle filter is subjected to a succession of filtration phases (accumulation of soot) and regeneration phases (removal of soot). During the filtration phases, the soot particles emitted by the engine are retained and deposited inside the filter. During the regeneration phases, the soot particles are burned inside the filter so as to restore its filtration properties.

The filters are more often made of a porous ceramic material, for example of cordierite or silicon carbide.

Although cordierite filters have been known and used for a long time, on account of their low cost, it is at the present time known that serious problems may occur in such structures, notably during badly controlled regeneration cycles, during which the filters may be subjected locally to temperatures above the melting point of cordierite. The consequences of these hot spots may extend from a partial loss of efficiency of the filter, to its total destruction in more severe cases. Moreover, cordierite does not have sufficient chemical inertia, with respect to the temperatures reached during successive regeneration cycles and it is, on account of this, liable to be corroded by reaction with metals accumulated in the structure during the filtration phases, it being possible for this phenomenon also to be the origin of rapid deterioration of the properties of the structure.

For example, such disadvantages are described in patent application WO 2004/01124 that proposes a filter based on aluminum titanate (60 to 90% by weight), reinforced by mullite (10 to 40% by weight), of which the durability is improved.

More recently, and partly to overcome such problems, filtration structures made of silicon carbide SiC have been described. Samples of such catalytic filters made of silicon carbide are described in patent applications EP 816 065, EP 1 142 619, EP 1 455 923 or WO 2004/090294 and WO 2004/065088.

SiC filters obtained according to the preceding publications make it possible to obtain chemically inert filtering structures within the previously described meaning, excellent thermal conductivity, for example greater than 12 W/m.K at 20° C., as is disclosed for example in patent application EP 1 652 831. In such structures, the porosity, the median diameter and the size distribution of the pores are ideal for applications for filtering soot coming from a heat engine.

However, certain defects inherent in this equipment still exist:

A first disadvantage is connected with the thermal expansion coefficient for SiC that is too high, approximately 4×10⁻⁶ K⁻¹, which does not allow large size monolithic filters to be produced, and more often makes it necessary to segment the filter into several honeycomb elements bonded by a cement, as is described in application EP 1 455 923.

A second disadvantage, of an economic nature, is connected with the extremely high firing temperature, typically above 2100° C., necessary for ensuring cintering, guaranteeing a sufficient thermomechanical strength of honeycomb structures and notably for withstanding the successive phases for regenerating the filter over all the life of the filter. Such temperatures require the installation of special equipment that increases substantially the cost of the filter finally obtained.

According to an alternative route, application EP 1 070 687 describes a structure based on SiC grains having a ceramic binding phase based on oxides comprising at least one simple oxide chosen notably from TiO₂ and Al₂O₃. Experience shows however that the materials described in the examples of this application do not have sufficient thermal stability.

The object of the present invention is thus to provide a honeycomb structure of a novel type, making it possible to respond to all the previously described problems.

In a general manner, the present invention relates to a structure of the honeycomb type, said structure consisting at least partly of a porous ceramic material comprising 45 to 90% by weight of silicon carbide SiC, preferably in the alpha form, and 10 to 55% by weight of a ceramic oxide phase substantially in the form of aluminum titanate Al₂TiO₅, said material also having a porosity greater than 10%, preferably between 20% and 60%, and a median pore size of between 5 and 60 microns, preferably between 10 and 25 microns.

The term “substantially” in the form of aluminum titanate Al₂TiO₅ is understood within the meaning of the present description to indicate that the oxide phase comprises at least 40% of aluminum titanate Al₂TiO₅, and preferably at least 50% by weight or even at least 60% by weight of aluminum titanate Al₂TiO₅, or even in a still more preferred manner at least 80% by weight of aluminum titanate Al₂TiO₅.

Preferably, the mass percentage of the SiC phase in the porous material lies between 50% and 85%, and in a very preferred manner between 60 and 80%.

Preferably, the mass percentage of Al₂TiO₅ in the porous material lies between 15% and 50% and in a very preferred manner between 20 and 40%.

According to the invention, the oxide phase present in the structure may include, apart from aluminum titanate, a minimum part, that is to say less than 10% by weight, or even less than 5% by weight of mullite Al₆Si₂O₁₃ (3Al₂O₃-2SiO₂) for example 0.01 to 10% by weight of mullite, preferably 1 to 5% by weight of mullite. It is important to note that the presence of mullite according to the invention is not obligatory. The presence of such a phase is in general inherent to the use of a source of silicon other than SiC, for example in the form of silica, in the initial mixture of powders, for example in the form of inevitable impurities. Without being bound by any particular theory, the supplementary presence of mullite could also result, under certain conditions, in a high reactivity of silica situated at the surface of the SiC grains towards alumina present in the mixture, at the temperature of the firing step of the monoliths.

Without departing from the scope of the invention, another refractory oxide phase notably based on, or a precursor of, magnesia MgO may also be introduced into the powder mixture.

The structures obtained according to the invention have a porosity suited to use as a particle filter, that is to say their porosity generally lies between 20 and 65% and the median pore diameter is ideally between 10 and 20 microns.

According to a possible embodiment of the invention, the structure comprises:
45 to 90% by weight of silicon carbide SiC,
55 to 10% by weight of an oxide ceramic phase essentially present in the form of aluminum titanate and comprising, based on the total mass of oxides present in the phase, 1 to 10% of SiO₂, 50 to 60% of Al₂O₃ and 35 to 50% of TiO₂ .

The filtering structure according to the invention is more often characterized by a central part comprising a honeycomb filtering element or a plurality of honeycomb filtering elements bonded together by a joining cement, said element or elements comprising an assembly of adjacent conduits or channels with axes parallel to each other separated by porous walls, these conduits being obstructed by stoppers at one or other of their ends in order to delimit inlet chambers opening along a face for the entry of gases and outlet chambers opening along a face for the evacuation of gases, so that the gas passes through the porous walls.

In general, the number of channels lies between 7.75 and 62 per cm², said channels having a cross section of 0.5 to 9 mm², the walls separating the channels having a thickness of approximately 0.2 to 1.0 mm, preferably 0.2 to 0.5 mm.

The invention also relates to a method for producing a structure as previously described, wherein said structure is obtained from an initial mixture of silicon carbide grains and aluminum titanate grains or from an initial mixture of silicon carbide grains, titanium oxide grains and aluminum oxide grains.

Advantageously, the silicon carbide powder has a median diameter d₅₀ of less than 125 microns, preferably between 10 and 50 microns, and the titanium oxide powder, the aluminum oxide powder or, alternatively, the aluminum titanate powder, have a median diameter d₅₀ less than 15 microns.

The median diameter d₅₀ of a powder or of an assembly of grains or particles corresponds, according to the invention, to the “median size”, that is to say the size dividing the particles or grains of this assembly into a first and second population equal in mass, these first and second populations only comprising grains having a size greater or less respectively than the median size. The “particle size” of a powder is conventionally understood to mean the particle size determined by sedigraphic analysis performed so as to characterize a particle size distribution. The sedigraphic analysis may for example be performed by means of a Sedigraph 5100 sedigraph from the Micromeritics® Company.

According to an alternative production method the structure according to the invention may also be obtained from an initial mixture of silicon carbide grains and aluminum titanate grains, of which a fraction of the atoms may be substituted notably by Mg atoms.

Advantageously, the aluminum titanate powder has a median diameter d₅₀ less than 60 microns, preferably les than 30 microns.

The production method more often comprises a step of blending the initial mixture resulting in a homogeneous product in the form of a paste, a step for extruding said product through a suitable die so as to form monoliths with a honeycomb form, a step of drying the monoliths obtained and possibly an assembly step and a firing step performed at a temperature not exceeding 1800° C., preferably not exceeding 1700° C.

For example, during the first step, a mixture is blended comprising at least one silicon carbide powder, an aluminum titanate powder or a mixture of titanium oxide and aluminum oxide and possibly 1 to 30% of a least one porogenic agent chosen according to the desired pore size, and then at least one organic plasticizer and/or an organic binder and water are added.

During the drying step, the unfired ceramic monoliths obtained are typically dried by microwave or at a temperature for a sufficient time in order to bring the chemically unbound water to less than 1% by weight.

The method for obtaining a particle filter additionally includes a step of closing one channel out of two at each end of the monolith.

In the firing step according to the invention, the monolithic structure is generally brought to a temperature of approximately between 1300° C. and approximately 1700° C., preferably between approximately 1400° C. and 1600° C., in an atmosphere containing oxygen.

The present invention relates in particular to a catalytic filter or a substrate obtained from a structure such as previously described and depositing, preferably by impregnation, at least one supported or preferably unsupported active catalytic phase, typically comprising at least one precious metal such as Pt and/or Rh and/or Pd and possibly an oxide such as CeO₂, ZrO₂, CeO₂-ZrO₂.

Such a structure notably finds an application as a catalytic substrate in an exhaust line of a diesel or gasoline engine or as a particle filter in an exhaust line of a diesel engine.

The invention and its advantages will be better understood when reading the following non-limiting examples.

In the examples, all percentages are expressed by weight.

### EXAMPLE 1 (ACCORDING TO THE INVENTION)

The following were mixed in a blender:
3750 g of a powder of SiC grains with a median diameter of approximately 30 microns,
120 g of an alumina powder marketed under reference CT3000SG by the Almatis Company, having a median grain diameter d₅₀ of approximately 0.6 microns,
100 g of PVA (polyvinyl alcohol),
300 g of water.

After this mixture had been homogenized and granules of sufficient mechanical strength had been obtained, these granules were blended with:
970 g of an alumina powder marketed under reference A17NE by the Almatis Company, and being differentiated notably from the first alumina powder by a median grain diameter d₅₀ of approximately 2.5 microns,
610 g of a titanium oxide powder of grade 3025 marketed by the Kronos Company,
150 g of an organic binder of the methylcellulose type.

Water was added and blending was carried out until a homogeneous paste was obtained, the plasticity of which enabled it to be extruded through a die with a honeycomb structure of which the dimensional properties are given in table 1:

TABLE 1

| Geometry of the channels | | |
|---|---|---|
| of the monolith | Square | |
| Density of the channels | 180 | cpsi |
| | (channels per square | |
| | inch, 1 inch = 2.54 cm) | |
| Thickness of the walls | 350 | μm |
| Length | 15.2 | cm |
| Width | 3.6 | cm |

The unfired monoliths obtained were then dried by microwave for a sufficient time to bring the non-chemically bound water to less than 1% by weight.

The channels of each face of the monolith were alternately closed by well-known techniques, for example those described in application WO 2004/065088.

The monolith was then fired in air progressively until a maximum temperature of 1500° C. was reached that was held for 4 hours.

Analysis by scanning electron microscopy showed a substantially homogeneous structure characterized by the presence of SiC grains and an oxide matrix consisting of an oxide phase of the mullite type representing less than 10% by weight of the material and a phase of the aluminum titanate type representing approximately 25% of the material forming this structure and establishing contact zones between said silicon carbide grains.

### EXAMPLE 2 (COMPARATIVE)

Following the techniques of the art, for example described in patents EP 816 065, EP 1 142 619, EP 1 455 923 or WO 2004/090294, monolithic elements were synthesized in the form of a honeycomb of which the dimensions were in accordance with those given in table 1, but made exclusively of silicon carbide.

To this end, the following were mixed in a blender:
3000 g of a mixture of silicon carbide particles with a purity greater than 98% and having a particle size distribution such that 70% by weight of the particles had a diameter greater than 10 micrometers, the median diameter of this particle size fraction being less than 300 micrometers. Within the meaning of the present description, the median diameter denotes the diameter of particles below which 50% of the population lies.
150 g of an organic binder of the cellulose type.

Water was added and blending was carried out until a homogenous paste was obtained, the plasticity of which enabled it to be extruded, the die being configured so as to obtain monolithic blocks of which the channels and outer walls had a square structure as in table 1.

The unfired monoliths obtained were dried by microwave for a sufficient time to bring the non-chemically bound water content to less than 1% by weight.

The channels of each face of the monolith were alternately closed according to well-known techniques, for example described in application WO 2004/065088.

The monoliths were then fired at a temperature of 2200° C. that was held for 5 hours. The porous material obtained, comprising to a very large extent crystallized α-Sic, had an open porosity of 47% and a mean pore diameter distribution of the order of 14 μm.

Table 2 gives the characteristics measured on the filter obtained according to example 1, by comparison with those of the filter already known of example 2 made exclusively α-SiC.

More particularly:

The porosity characteristics were measured by porosimetric analyses with a high mercury pressure, carried out with a porosimeter of the Micromeritics type 9500 type.

The thermal conductivity properties were measured by flash laser.

The thermal expansion coefficient was measured from ambient temperature to 1000° C. by dilatometry.

The weight percentages of aluminum titanate and mullite in the oxide phase were determined by X-ray diffraction.

The weight percentage of silicon carbide was measured by chemical analysis.

The thermomechanical properties of the filters were evaluated in the following way:

The filters of examples 1 and 2 were mounted on an exhaust line of a 2.0 L diesel engine with direct injection run at full power (4000 rpm) for 30 minutes and then dismantled and weighed in order to determine the initial mass. The filters were then remounted on an engine test bench with an engine speed of 3000 rpm and a torque of 50 Nm for various periods in order to obtain a soot loading of 8 g/liter (based on the volume of the filter). The filters loaded in this way were remounted on the line in order to undergo strict regeneration defined in this way: after stabilization at an engine speed of 1700 rpm for a torque of 95 Nm for 2 minutes, post-injection was carried out with 70° phasing for a post-injection flow rate of 18 mm³/stroke. Once the combustion of soot had been initiated, more precisely when the loss of load fell for at least 4 seconds, the engine speed was reduced to 1050 rpm for a torque of 40 Nm for 5 minutes in order to accelerate the combustion of soot. The filter was then subjected to an engine speed of 4000 rpm for 30 minutes in order to eliminate the remaining soot.

The regenerated filters were inspected after being cut up in order to reveal the presence of any fissures visible to the naked eye. The thermomechanical strength of the filter was assessed from the number of fissures, a small number of fissures resulting in an acceptable thermomechanical strength for use as a particle filter.

As shown in table 2, the following marks were assigned to each of the filters:

TABLE 2

| | Filter | Filter according |
|---|---|---|
| | exclusively of | to the invention |
| | SiC-Example 2 | Example 1 |
| SiC | >99% | 67% |
| Oxide phase | <1% | 33% |

Of which

| | | |
|---|---|---|
| Aluminum titanate | − | 75% |
| Mullite | − | 5% |
| Vitreous phase | − | 20% |

Parameters of the method for obtaining

| | | |
|---|---|---|
| Firing temperature | 2100° C. | 1500° C. |
| Atmosphere | Argon | Air |

Properties of the filter

| | | |
|---|---|---|
| Open porosity (%) | 47 | 42 |
| Median pore diameter | 14 | 13 |
| (microns) | | |
| Thermal conductivity | 15 | 5 |
| at 20° C. (W/m · K⁻¹) | | |
| Dilatometric | <0.05 | <0.5 |
| shrinkage at 1400° C. | | |
| (in %) | | |
| Mean coefficient of | 4.4 | 2.8 |
| thermal expansion | | |
| (CTE) between 20 and | | |
| 1000° C. (10⁻⁶/° C.) | | |
| Presence of fissures | ++ | + |
| after soot loading of | | |
| 8 g/l and strict | | |
| regeneration | | |

+++: presence of very many fissures,
++: presence of many fissures,
+: presence of a few fissures,
−: no fissures or very few fissures.

A comparison of the data of table 2 between the two filters shows the beneficial effects for the application, obtained by virtue of the supplementary presence of the oxide phase according to the invention, comprising essentially aluminum titanate. Thus, the following were observed:
the obtaining of porosity characteristics of the same order in spite of a much lower sintering temperature than for the conventional filter made exclusively of SiC,
a coefficient of thermal conductivity a little lower than that of the filter made exclusively of SiC, but which remained excellent for use of the material as a particle filter,
a mean coefficient of thermal expansion between 20 and 1000° C. substantially lower for the SiC-oxide filter, which constitutes a decisive advantage compared with 100% SiC structure as previously explained and leads notably to the possibility of producing large size monolithic filters, in particular with a large diameter,
a thermomechanical strength greater than that of the reference filter made of recrystallized SiC, for substantially identical porosity parameters.

Moreover, as may be seen in table 2, the structure according to the invention was obtained at a temperature approximately 600° C. below that which was necessary for producing a filter made of recrystallized

SiC which enables a substantial saving to be made to the cost of obtaining the filter. Studies have shown that the saving achieved only by lowering the firing temperature represents at least a third of the overall cost price of a filter.

Electron microscopic analyses showed that the porous filtering structure obtained in example 1 consisted of SiC grains, and also showed the presence of the oxide phase substantially consisting of aluminum titanate between SiC grains.

The filter according to the invention, loaded with 4 g/l of soot, was tested on an engine test bench. It was verified that the filtration efficiency, measured by a probe of the SMPS type (Scanning Mobility Particles Sizer) was satisfactory.

In the preceding description and examples, for reasons of simplicity, the invention has been described in relation to catalyzed particle filters enabling pollutant gases and soot present in the exhaust gas leaving an exhaust line of a diesel engine to be eliminated.

The present invention however also relates to catalytic substrates enabling pollutant gases leaving gasoline or even diesel engines to be eliminated. In this type of structure, the channels of the honeycomb are not closed at one or other of their ends. Applied to these substrates, implementation of the present invention presents the advantage of increasing the specific surface area of the substrate and consequently the quantity of active phase present in the substrate, without for all that affecting the overall porosity of the substrate.

1. A honeycomb structure comprising a porous ceramic material, said porous ceramic material comprising at least 45 to 90% by weight of silicon carbide SiC, and 10 to 55% by weight of a ceramic oxide phase substantially in the form of aluminum titanate Al₂TiO₅, said material also having a porosity greater than 10%, and a median pore diameter of between 5 and 60 microns.

2. The honeycomb structure as claimed in claim 1, wherein the mass percentage of the SiC phase in the porous material is between 50% and 85%.

3. The honeycomb structure as claimed in claim 1, wherein the mass percentage of Al2TiO₅ in the porous material is between 15% and 50%.

4. The honeycomb structure as claimed in claim 1, wherein the oxide phase additionally comprises 0.01 to 10% of mullite.

5. The honeycomb structure as claimed in claim 1, wherein the porosity is between 20 and 65% and the median pore diameter is between 10 and 20 microns.

6. The honeycomb structure as claimed in claim 1, comprising:
45 to 90% by weight of silicon carbide SiC,
55 to 10% by weight of an oxide ceramic phase essentially present in the form of aluminum titanate and comprising, based on the total mass of oxides present in said phase, 1 to 10% of SiO₂, 50 to 60% of Al₂O₃ and 35 to 50% of TiO₂.

7. The honeycomb structure as claimed in claim 1 comprising a central part, wherein the central part comprises a honeycomb filtering element or a plurality of honeycomb filtering elements bonded together by a joining cement, said element or elements comprising an assembly of adjacent conduits or channels with axes parallel to each other separated by at least one porous wall having at least one end, these conduits being obstructed by a stopper at the at least one end in order to delimit inlet chambers opening along a face for the entry of gases and outlet chambers opening along a face for the evacuation of gases, so that the gas passes through the porous wall.

8. A catalytic filter or substrate comprising at least one supported or unsupported active catalytic phase comprising at least one precious metal such as Pt and/or Rh and/or Pd and possibly an oxide such as CeO₂, ZrO₂, CeO₂-ZrO₂, deposited or impregnated on the honeycomb structure of claim 1.

9. A method for producing a structure as claimed in claim 1, wherein said structure is obtained from mixing silicon carbide grains and aluminum titanate grains or from mixing silicon carbide grains, titanium oxide grains and aluminum oxide grains to obtain an initial mixture.

10. The method for producing a structure as claimed in claim 9, comprising blending the initial mixture resulting in a homogeneous product in the form of a paste, extruding said product through a suitable die so as to form monoliths with a honeycomb form, drying the monoliths obtained, and optionally assembling and firing said monoliths at a temperature not exceeding 1800° C.
